(19) United States
(12) Patent Application Publication
(10) Pub. No.: US 2022/0205865 A1
(43) Pub. Date: Jun. 30, 2022

(54) Lighter-than-air (LTA) Vehicle Health and Lifetime Estimation

(71) Applicant: LOON LLC, Mountain View, CA (US)

(72) Inventors: Sameera Sylvia Ponda, Mountain View, CA (US); Salvatore J. Candido, Mountain View, CA (US)

(73) Assignee: LOON LLC, Mountain View, CA (US)

(21) Appl. No.: 17/135,368

(22) Filed: Dec. 28, 2020

(51) Int. Cl. G01M 3/32; G08G 5/00; B64B 1/00; G01M 17/00

(52) U.S. Cl. CPC G01M 3/3236; G01M 17/00; B64B 1/00; G08G 5/0017

(57) ABSTRACT

The technology relates to health and lifetime estimation for a lighter-than-air (LTA) vehicle. An LTA vehicle health and lifetime estimation system may include a processor and a memory storing instructions executable by the processor to cause the processor to implement an estimation service for determining a remaining lifetime output and a simulator for simulating a terminal event based on the remaining lifetime output. The estimation service may include a thermal model configured to determine a gas temperature, a gas and air estimator configured to estimate a gas amount and an air amount remaining in a balloon of the LTA vehicle, a leak rate estimator configured to estimate a leak rate, and a zero pressure estimator configured to determine the remaining lifetime output based on the leak rate. The system also may include an air flow estimator configured to determine an air mass flow rate based on the air amount.

### BACKGROUND OF INVENTION

Lighter-than-air (LTA) vehicles are being deployed for many different types of missions and purposes, including providing data connectivity (e.g., broadband and other wireless services), weather observations, Earth observations, cargo transport, and more. Different missions entail different objectives, including different expected vehicle lifetimes, altitude ranges, climates traveled. Such LTA vehicles are in flight for long periods of time and are being directed to new missions without landing and re-launching, which means the vehicles and vehicle components cannot be manually examined and evaluated between missions. They also operate at high altitudes and in extreme conditions where traditional sensors can be unreliable. Thus, direct sensor readings are insufficient to provide a clear picture of an LTA vehicle's health. These factors render monitoring of the vehicle's health and accurate estimations of the length of time that the vehicles can remain operational both essential and difficult.

Thus, there is a need for improved LTA vehicle health and lifetime estimation.

### BRIEF SUMMARY

The present disclosure provides techniques for health and lifetime estimation for a lighter-than-air (LTA) vehicle. An LTA vehicle health and lifetime estimation system may include a processor; and a memory comprising program instructions executable by the processor to cause the processor to implement: an estimation service configured to determine a remaining lifetime output, the estimation service comprising: a thermal model configured to determine a gas temperature, a gas and air estimator configured to estimate a gas amount and an air amount remaining in a balloon of the LTA vehicle, a leak rate estimator configured to estimate a leak rate based on the gas amount, and a zero pressure estimator configured to determine the remaining lifetime output based on the leak rate; and a simulator configured to simulate a terminal event based on the remaining lifetime output. In some examples, the system also may include an air flow estimator configured to determine an air mass flow rate based on the air amount, wherein the zero pressure estimator is further configured to consider the air mass flow rate in determining the remaining lifetime output.

In some examples, the estimation service is configured to receive flight data. In some examples, the flight data comprises current flight data from a vehicle. In some examples, the flight data comprises historical flight data from a vehicle. In some examples, the flight data comprises a characteristic of a vehicle. In some examples, the flight data comprises a modeled input parameter. In some examples, the flight data comprises aggregated flight data from a flight data aggregator. In some examples, the remaining lifetime output comprises a value. In some examples, the remaining lifetime output comprises a probabilistic output. In some examples, the remaining lifetime output comprises a survival curve.

In some examples, the thermal model determines the gas temperature based on one or more of sensor data, a plurality of simulations, an expected flight path, an ambient temperature, an ambient pressure, and local heat flux. In some examples, the thermal model derives the gas temperature from one or more forms of radiation (q). In some examples, the thermal model is configured to model one or both of convection and vehicle energy emissions for a vehicle. In some examples, the thermal model is configured to rely more heavily on a lift gas temperature sensor measurement when the gas temperature is below a temperature threshold. In some examples, the thermal model is configured to fuse a lift gas temperature sensor measurement with a modeled gas temperature estimate.

In some examples, the leak rate estimator is further configured to determine a hole size. In some examples, the leak rate estimator estimates the leak rate using an extended Kalman filter. In some examples, the simulator is configured to run a plurality of Monte Carlo simulations.

In some examples, the system also includes one or more component health estimators configured to determine a probability of failure for a component. In some examples, the remaining lifetime output is further based on a component lifetime. In some examples, the one or more component health estimators comprises an altitude control system (ACS) health estimator. In some examples, the one or more component health estimators comprises a power system health estimator.

A method for lighter-than-air (LTA) vehicle health and lifetime estimation may include receiving a plurality of flight data inputs associated with a vehicle; determining a gas temperature based on the plurality of flight data inputs; estimating a gas amount remaining in a balloon envelope of the vehicle; estimating a gas leak rate based on the gas amount; and determining a remaining lifetime output based on the gas leak rate, the remaining lifetime output indicating a remaining lifetime estimate for the vehicle. In some examples, the method also includes determining a hole size based on the gas amount, wherein determining the remaining lifetime output value is further based on the hole size. In some examples, the method also includes estimating an air amount remaining in the balloon envelope, the air amount comprising an amount of air pumped into and let out of the balloon envelope; and determining an air mass flow rate based on the air amount, the remaining lifetime output being further based on the air mass flow rate. In some examples, the method also includes simulating a burst event. In some examples, the method also includes simulating a zero pressure event. In some examples, the method also includes causing the vehicle to take an action based on the remaining lifetime output. In some examples, causing the vehicle to take the action comprises providing the remaining lifetime output to an alerts monitor configured to send an alert to the vehicle. In some examples, causing the vehicle to take the action comprises: providing the remaining lifetime output to a planner; modifying, by the planner, a flight plan for the vehicle; and sending a command to the vehicle based on the flight plan.

In some examples, the remaining lifetime output comprises a value indicating the remaining lifetime estimate. In some examples, the remaining lifetime output comprises a probability that the vehicle will experience a terminal event within the remaining lifetime estimate. In some examples, the remaining lifetime output comprises a survival curve predicting a likelihood of a terminal event over a temperature axis and a time axis.

In some examples, determining the gas temperature comprises fusing an infrared radiation estimate and a lift gas temperature estimate. In some examples, the infrared radiation estimate is based at least in part on an infrared radiation sensor measurement. In some examples, the lift gas temperature estimate is based at least in part on a lift gas temperature sensor measurement. In some examples, determining the gas temperature comprises modeling a thermal property of the vehicle based on one or more of the following thermal radiation inputs: a solar radiation, an upwelling infrared radiation, a convection, a vehicle energy emission, and a reflected heat. In some examples, the gas amount is housed in a ballonet within the balloon envelope.

In some examples, the plurality of flight data inputs comprises current flight data. In some examples, the plurality of flight data inputs comprises vehicle flight historical data. In some examples, the plurality of flight data inputs comprises a characteristic of the vehicle.

A distributed computing system may include a distributed database configured to store flight data for a plurality of flights; and one or more processors configured to perform operations for estimating health and lifetime of an LTA vehicle, the one or more processors configured to: receive a plurality of flight data inputs associated with a vehicle, determine a gas temperature based on the plurality of flight data inputs, estimate a gas amount remaining in a balloon envelope of the vehicle, estimate a gas leak rate based on the gas amount, and determine a remaining lifetime output based on the gas leak rate, the remaining lifetime output indicating a remaining lifetime estimate for the vehicle. In some examples, the flight data comprises aggregated flight data. In some examples, the plurality of flights includes a flight being performed by the vehicle.

A method for lighter-than-air (LTA) vehicle health and lifetime estimation may include receiving a plurality of flight data inputs associated with a vehicle; determining a gas temperature based on the plurality of flight data inputs; estimating a gas amount remaining in a balloon envelope of the vehicle; estimating a gas leak rate based on the gas amount; estimating a component lifetime comprising an estimated lifetime of a component of the vehicle; and determining a remaining lifetime output based on one or both of the gas leak rate or the component lifetime, the remaining lifetime output indicating a remaining lifetime estimate for the vehicle. In some examples, determining the remaining lifetime output comprises estimating a number of days until a likelihood of the vehicle experiencing a zero pressure event exceeds a zero pressure probability threshold; and comparing the number of days with the component lifetime. In some examples, estimating the component lifetime comprises estimating a number of days until a likelihood of the component performing below a component performance threshold. In some examples, the component comprises an altitude control system (ACS) and the component performance threshold comprises an ACS failure probability threshold. In some examples, the component comprises a battery power system and the component performance threshold comprises a battery charge threshold. In some examples, the method also includes estimating an air amount remaining in the balloon envelope, the air amount comprising an amount of air pumped into and let out of the balloon envelope; and determining an air mass flow rate based on the air amount, the remaining lifetime output being further based on the air mass flow rate.

In some examples, the method also includes simulating a burst event. In some examples, the method also includes simulating a zero pressure event. In some examples, the method also includes causing the vehicle to take an action based on the remaining lifetime output. In some examples, causing the vehicle to take the action comprises providing the remaining lifetime output to an alerts monitor configured to send an alert to the vehicle. In some examples, causing the vehicle to take the action comprises: providing the remaining lifetime output to a planner; and modifying, by the planner, a flight plan for the vehicle; and sending a command to the vehicle based on the flight plan. In some examples, the remaining lifetime output comprises a value indicating the remaining lifetime estimate. In some examples, the remaining lifetime output comprises a probability that the vehicle will experience a terminal event within the remaining lifetime estimate. In some examples, the remaining lifetime output comprises a survival curve predicting a likelihood of a terminal event over a temperature axis and a time axis. In some examples, determining the gas temperature comprises fusing an infrared radiation estimate and a lift gas temperature estimate. In some examples, the infrared radiation estimate is based at least in part on an infrared radiation sensor measurement. In some examples, the lift gas temperature estimate is based at least in part on a lift gas temperature sensor measurement. In some examples, determining the gas temperature comprises modeling a thermal property of the vehicle based on one or more of the following thermal radiation inputs: a solar radiation, an upwelling infrared radiation, a convection, a vehicle energy emission, and a reflected heat. In some examples, the plurality of flight data inputs comprises current flight data. In some examples, the plurality of flight data inputs comprises vehicle flight historical data. In some examples, the plurality of flight data inputs comprises a characteristic of the vehicle.

A distributed computing system may include a distributed database configured to store flight data for a plurality of flights; and one or more processors configured to perform operations for estimating health and lifetime of an LTA vehicle, the one or more processors configured to: receive a plurality of flight data inputs associated with a vehicle, determine a gas temperature based on the plurality of flight data inputs, estimate a gas amount remaining in a balloon envelope of the vehicle, estimate a gas leak rate based on the gas amount, estimate a component lifetime comprising an estimated lifetime of a component of the vehicle, and determine a remaining lifetime output based on one or both of the gas leak rate or the component lifetime, the remaining lifetime output indicating a remaining lifetime estimate for the vehicle. In some examples, the flight data comprises aggregated flight data.

### BRIEF DESCRIPTION OF THE DRAWINGS

FIGS. 1A-1B are diagrams of exemplary lighter-than-air vehicles for which health and lifetime may be estimated, in accordance with one or more embodiments;

FIG. 2 is a diagram of an exemplary aerial vehicle network, in accordance with one or more embodiments;

FIG. 3A is a simplified block diagram of an exemplary computing system forming part of the systems of FIGS. 1A-2, in accordance with one or more embodiments;

FIG. 3B is a simplified block diagram of an exemplary distributed computing system that may be used to perform health and lifetime estimation methods, in accordance with one or more embodiments;

FIG. 4 is a simplified block diagram of an exemplary LTA vehicle health and estimation system, in accordance with one or more embodiments;

FIG. 5A is a simplified diagram of exemplary sources of thermal radiation that may be considered in a thermal model in the LTA vehicle health and estimation system of FIG. 4, in accordance with one or more embodiments;

FIG. 5B is a simplified block diagram of exemplary inputs and output of a thermal model in the LTA vehicle health and estimation system of FIG. 4, in accordance with one or more embodiments; and

FIGS. 6A-6B are flow diagrams illustrating methods for LTA vehicle health and lifetime estimation, in accordance with one or more embodiments.

The figures depict various example embodiments of the present disclosure for purposes of illustration only. One of ordinary skill in the art will readily recognize from the following discussion that other example embodiments based on alternative structures and methods may be implemented without departing from the principles of this disclosure, and which are encompassed within the scope of this disclosure.

### DETAILED DESCRIPTION

The Figures and the following description describe certain embodiments by way of illustration only. One of ordinary skill in the art will readily recognize from the following description that alternative embodiments of the structures and methods illustrated herein may be employed without departing from the principles described herein. Reference will now be made in detail to several embodiments, examples of which are illustrated in the accompanying figures.

The above and other needs are met by the disclosed methods, a non-transitory computer-readable storage medium storing executable code, and systems for dispatching fleets of aircraft by a fleet management and flight planning system. The terms “aerial vehicle” and “aircraft” are used interchangeably herein to refer to any type of vehicle capable of aerial movement, including, without limitation, High Altitude Platforms (HAPs), High Altitude Long Endurance (HALE) aircraft, unmanned aerial vehicles (UAVs), passive lighter than air (LTA) vehicles (e.g., floating stratospheric balloons, other floating or wind-driving vehicles), powered lighter than air vehicles (e.g., balloons and airships with some propulsion capabilities), fixed-wing vehicles (e.g., drones, rigid kites, gliders), various types of satellites, and other high altitude aerial vehicles.

The invention is directed to a health and lifetime estimation system and methods for lighter-than-air (LTA) vehicles. The LTA vehicle health and lifetime estimation system comprises an estimation service configured to use flight data inputs to compute an air and lift gas leak rate (e.g., based on outputs from lift gas and air estimators indicating a rate of change in lift gas and air over time), a zero pressure estimator configured to use the air and gas leak rate to estimate a remaining lifetime value (e.g., number of days, value representing projected loss of lift gas or remaining lift gas over time (i.e., deterministic), computed or simulated probabilities of remaining days airborne until zero pressure (i.e., probabilistic)), and a simulator configured to simulate burst and zero pressure events. The health of a component (e.g., navigation, power, other hardware subsystem, and other component) of the LTA vehicle also may be estimated, the component health estimates used as inputs to the simulator, which may further simulate expected lifespans (or failures) of said components and base an LTA vehicle lifespan on the health of one or more constrained components. The terms “lifespan” and “lifetime” are used interchangeably herein to mean an amount of time between a launch and a landing during which an LTA vehicle may have a full set of, or substantial, mission capabilities (e.g., can perform all or most or a threshold amount of missions for said vehicle type, which in some cases may include the full amount of time between the launch and the landing, and also may be related to its ability to access most or all of a steering range (e.g., between a bursting pressure threshold and a zero pressure threshold, which may be set to include a buffer below an actual bursting pressure and above an actual zero pressure)), which may be expressed as a value, a risk (e.g., odds or probability of a zero pressure in within a given time frame (e.g., 15 days, 20 days, 2 months, etc.), and distribution of values or probabilities over time.

Flight data inputs may include current flight data (e.g., ambient temperature, upwelling infrared radiation (IR) and other IR, solar radiation, pressure, location, weather, battery charge, solar power generation, component states (e.g., on, off, unresolved bugs)), vehicle flight historical data (e.g., days in flight, conditions flown (e.g., temperatures, altitudes, distance, geographical regions experienced so far in the flight), ACS activity, reported and/or resolved bugs and failures, number of reboots), characteristics of the vehicle (e.g., system mass, ballonet and other materials characteristics, volume, hardware and software versions and/or capabilities, battery or other power capacity), as well as modeled input parameters (e.g., convection, vehicle energy emissions (e.g., black body radiation, radiant heat, and other radiant energy)).

The estimation service may include a thermal model, a gas and air estimator, air flow rate estimator, a leak rate estimator, a zero pressure estimator, a power system health estimator (i.e., battery power health estimator), an ACS health estimator, as well as other estimators. Estimators may be configured to perform simulations, computations, modeling, and other functions to determine optimized outputs (e.g., in the form of values, probabilities, ensembles). The thermal model may be configured to determine a gas temperature (i.e., temperature of a gas in a ballonet of the vehicle) based on inputs relating to one or a combination of solar radiation, upwelling IR, convection, vehicle energy emissions. The thermal model may be configured to select and/or fuse data from a plurality of sources, including ballonet internal gas temperature sensor (e.g., may be more accurate during nighttime, may require adjustment or correction with other temperature data sources during daytime), IR sensor, and weather and IR data from forecast and nowcast models (e.g., National Oceanic and Atmospheric Administration's (NOAA's) Global Forecast System (GFS), European Center for Medium-Range Weather Forecast's (ECMWF's) high resolution forecasts (HRES), and the like).

The gas and air estimator may be configured to determine an amount of gas (mol_{gas}) and air (molₐᵢᵣ) remaining in the vehicle based on the gas temperature determined by the thermal model, as well as inputs relating to system mass, a balloon volume model, envelope and ballonet material (i.e., film) characteristics, ambient temperature, and internal and external pressure measurements (e.g., ambient pressure and internal gas pressure). The air flow rate estimator may be configured to determine a rate of flow of air mass (i.e., air mass flow rate) in or out of the balloon based on the air mass estimates (mol_{gas} and molₐᵢᵣ) output by the gas and air estimator, as well as ACS activity (e.g., how much air ACS has pumped into and let out of the balloon). The leak rate estimator may be configured to determine one or both of a gas leak rate and a hole size based on the mol_{gas} and molₐᵢᵣ output by the gas and air estimator (i.e., frequency and timing of vehicle ascents and descents, power settings being used during descents, etc.). The leak rate estimator may be configured to determine one or both of a gas leak rate and a hole size based on the gas mass estimates output by the gas and air estimator. The leak rate estimator may use a filter (e.g., Kalman filter, extended Kalman filter) to determine the gas leak rate and the hole size with relatively noisy gas and air mass estimates.

The zero pressure estimator may be configured to determine a remaining lifetime output (e.g., value, probability, survival curve indicating zero pressure predictions by temperature and time, other projection of failure probabilities or longevity estimations by intersecting vehicle position and weather forecast at a given time) based on the gas leak rate and the hole size as output by the leak rate estimator. In some examples, the zero pressure estimator may further consider the air mass flow rate as output by the air flow rate estimator in determining the remaining lifetime output. In some examples, the remaining lifetime output may comprise a value indicating a remaining lifetime (e.g., in number of days). In other examples, the remaining lifetime output may comprise a probability of experiencing a terminal event (i.e., an event requiring landing the vehicle) or conversely a probability of not experiencing a terminal event (e.g., a forecast for each day or other time increment (e.g., hours, weeks, months, etc) to a given horizon). In still other examples, the remaining lifetime may be represented as a survival curve and intersecting a weather forecast (or odds of being below a zero pressure temperature on the curve) for the vehicle's position at each time on a given horizon with the survival curve to determine odds or estimate of the vehicle's longevity. In some examples, the remaining lifetime output may indicate a life expectancy of the vehicle before a burst or zero pressure event is expected to occur.

In other examples, an output from one or a combination of two or more of a gas-air estimator, leak rate estimator, air flow estimator, power system health estimator, and ACS health estimator (e.g., leak rate, hole size, air mass flow rate, ACS cycles, battery and solar power charging cycles) may be provided as input to a lifetime estimation module configured to calculate an estimated lifespan as well as other information, including an amount of gas left in a vehicle, a failure rate of the ACS system as a function of cycles (e.g. how many days of use until the probability of ACS failure goes above a predetermined threshold), battery capacity deterioration rate (e.g., whether there is sufficient battery life and performance to complete the vehicle's mission or operate through a night or other period of time without solar energy production), a probability of envelope film failure (e.g. based on film-based properties such as elasticity, hoop stress, how much time spent above a given strain rate (e.g., solar flux and strain), UV degradation, thermal stress). In an example, the most limiting of such factors may determine a remaining lifetime of a vehicle (e.g., determine a time to take a vehicle out of service if any one probability (e.g., of bursting, of zero pressuring, of insufficient battery performance, of ACS failure, etc.) falls below a respective threshold probability (e.g., bursting probability threshold, zero pressure probability threshold, insufficient battery performance probability threshold, ACS failure threshold, etc.).

In some examples, the simulator may perform a plurality of simulations to determine probabilities of a terminal event (e.g., bursting and zero pressure events, battery and ACS system failure events) based on the remaining lifetime output and a flight plan or trajectory (e.g., Monte Carlo simulation, computing the probability of a termination event based on a vehicle's mission, which may be constrained by various mission-related factors, such as geography, flight plan, type of service, length of service). In some examples, the results of the simulations (e.g., probability of a vehicle having a lifespan of a desired length (e.g., number of days, weeks), the highest lifespan length for which the probability meets or exceeds a threshold lifetime probability) may be provided to an alerts monitor configured to send alerts to the vehicle and a planner configured to generate and modify flight plans. The output lifetime estimate also may be provided to various other flight and fleet management systems, including risk management systems, vehicle allocation and dispatcher systems. For example, the remaining lifetime estimate also may be merged (e.g., with other health estimates or lifetime estimates for other vehicles in a fleet) to generate a risk profile or longevity estimate for the flight system as a whole, and to determine when to take a vehicle out of service.

Example Systems

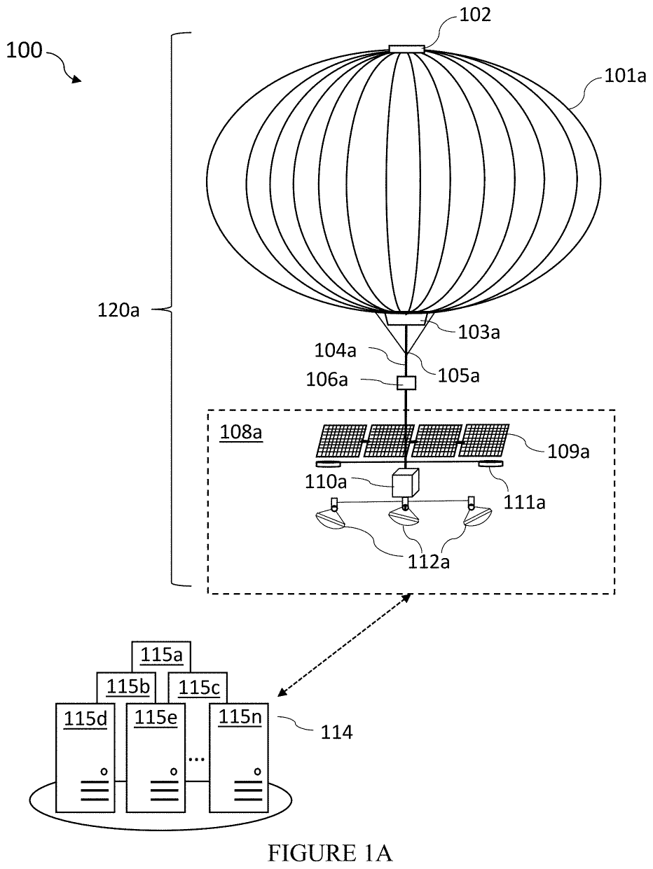

FIGS. 1A-1B are diagrams of exemplary lighter-than-air vehicles for which health and lifetime may be estimated, in accordance with one or more embodiments. In FIG. 1A, there is shown a diagram of system 100 for control of aerial vehicle 120a. In some examples, aerial vehicle 120a may be a passive vehicle, such as a lighter-than-air (LTA) vehicle or satellite, wherein most of its directional movement is a result of environmental forces, such as wind and gravity. In other examples, aerial vehicles 120a may be actively propelled or hybrid (i.e., partially propelled). In an embodiment, system 100 may include aerial vehicle 120a and ground station 114. In this embodiment, aerial vehicle 120a may include balloon 101a, plate 102, altitude control system (ACS) 103a, connection 104a, joint 105a, actuation module 106a, and payload 108a. In some examples, plate 102 may provide structural and electrical connections and infrastructure. Plate 102 may be positioned at the apex of balloon 101a and may serve to couple together various parts of balloon 101a. In other examples, plate 102 also may include a flight termination unit, such as one or more blades and an actuator to selectively cut a portion and/or a layer of balloon 101a. In other examples, plate 102 further may include other electronic components (e.g., a sensor, a part of a sensor, power source, communications unit). ACS 103a may include structural and electrical connections and infrastructure, including components (e.g., fans, valves, actuators, etc.) used to, for example, add and remove air from balloon 101a (i.e., in some examples, balloon 101a may include an interior ballonet within its outer, more rigid shell that may be inflated and deflated), causing balloon 101a to ascend or descend, for example, to catch stratospheric winds to move in a desired direction. Balloon 101a may comprise a balloon envelope comprised of lightweight and/or flexible latex or rubber materials (e.g., polyethylene, polyethylene terephthalate, chloroprene), tendons (e.g., attached at one end to plate 102 and at another end to ACS 103a) to provide strength and stability to the balloon structure, and a ballonet (i.e., a semi-rigid or non-rigid hull or enclosure designed to hold a volume of gas (e.g., helium or hydrogen) and/or air to lift an LTA vehicle), along with other structural components. In various embodiments, balloon 101a may be non-rigid, semi-rigid, or rigid.

Connection 104a may structurally, electrically, and communicatively, connect balloon 101a and/or ACS 103a to various components comprising payload 108a. In some examples, connection 104a may provide two-way communication and electrical connections, and even two-way power connections. Connection 104a may include a joint 105a, configured to allow the portion above joint 105a to pivot about one or more axes (e.g., allowing either balloon 101a or payload 108a to tilt and turn). Actuation module 106a may provide a means to actively turn payload 108a for various purposes, such as improved aerodynamics, facing or tilting solar panel(s) 109a advantageously, directing payload 108a and propulsion units (e.g., propellers 107 in FIG. 1B) for propelled flight, or directing components of payload 108a advantageously.

Payload 108a may include solar panel(s) 109a, avionics chassis 110a, broadband communications unit(s) 111a, and terminal(s) 112a. Solar panel(s) 109a may be configured to capture solar energy to be provided to a battery or other energy storage unit, for example, housed within avionics chassis 110a. Avionics chassis 110a also may house a flight computer (e.g., computing device 301, as described herein), a transponder, along with other control and communications infrastructure (e.g., a controller comprising another computing device and/or logic circuit configured to control aerial vehicle 120a). Communications unit(s) 111a may include hardware to provide wireless network access (e.g., LTE, fixed wireless broadband via 5G, Internet of Things (IoT) network, free space optical network or other broadband networks). Terminal(s) 112a may comprise one or more parabolic reflectors (e.g., dishes) coupled to an antenna and a gimbal or pivot mechanism (e.g., including an actuator comprising a motor). Terminal(s) 112(a) may be configured to receive or transmit radio waves to beam data long distances (e.g., using the millimeter wave spectrum or higher frequency radio signals). In some examples, terminal(s) 112a may have very high bandwidth capabilities. Terminal(s) 112a also may be configured to have a large range of pivot motion for precise pointing performance. Terminal(s) 112a also may be made of lightweight materials.

In other examples, payload 108a may include fewer or more components, including propellers 107 as shown in FIG. 1B, which may be configured to propel aerial vehicles 120a-b in a given direction. In still other examples, payload 108a may include still other components well known in the art to be beneficial to flight capabilities of an aerial vehicle. For example, payload 108a also may include energy capturing units apart from solar panel(s) 109a (e.g., rotors or other blades (not shown) configured to be spun, or otherwise actuated, by wind to generate energy). In another example, payload 108a may further include or be coupled to an imaging device, such as a downward-facing camera and/or a star tracker. In yet another example, payload 108a also may include various sensors (not shown), for example, housed within avionics chassis 110a or otherwise coupled to connection 104a or balloon 101a. Such sensors may include Global Positioning System (GPS) sensors, wind speed and direction sensors such as wind vanes and anemometers, temperature sensors such as thermometers and resistance temperature detectors (i.e., RTDs), speed of sound sensors, acoustic sensors, pressure sensors such as barometers and differential pressure sensors, accelerometers, gyroscopes, combination sensor devices such as inertial measurement units (IMUs), light detectors, light detection and ranging (LIDAR) units, radar units, cameras, other image sensors, and more. These examples of sensors are not intended to be limiting, and those skilled in the art will appreciate that other sensors or combinations of sensors in addition to these described may be included without departing from the scope of the present disclosure.

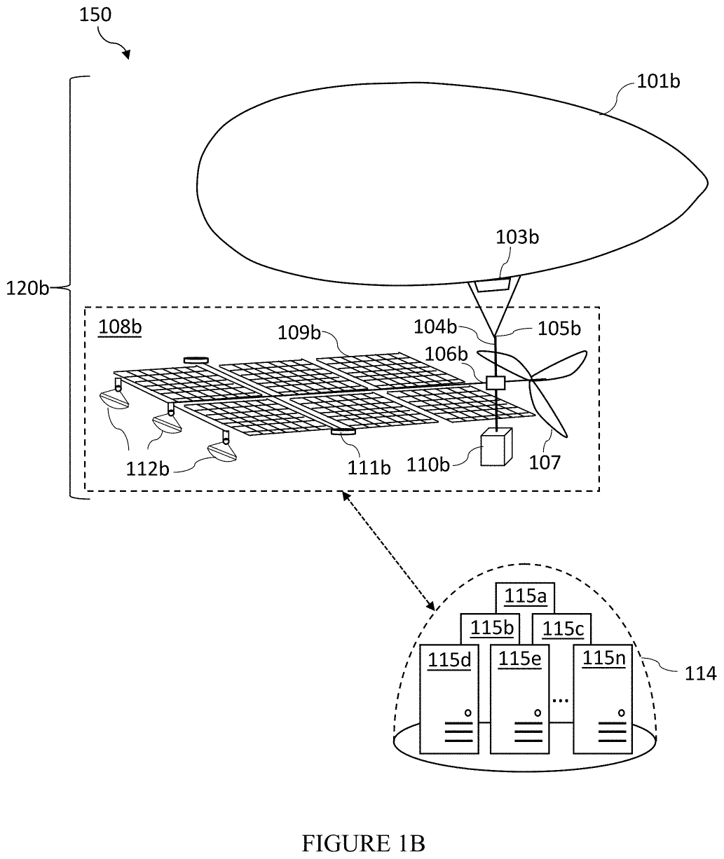

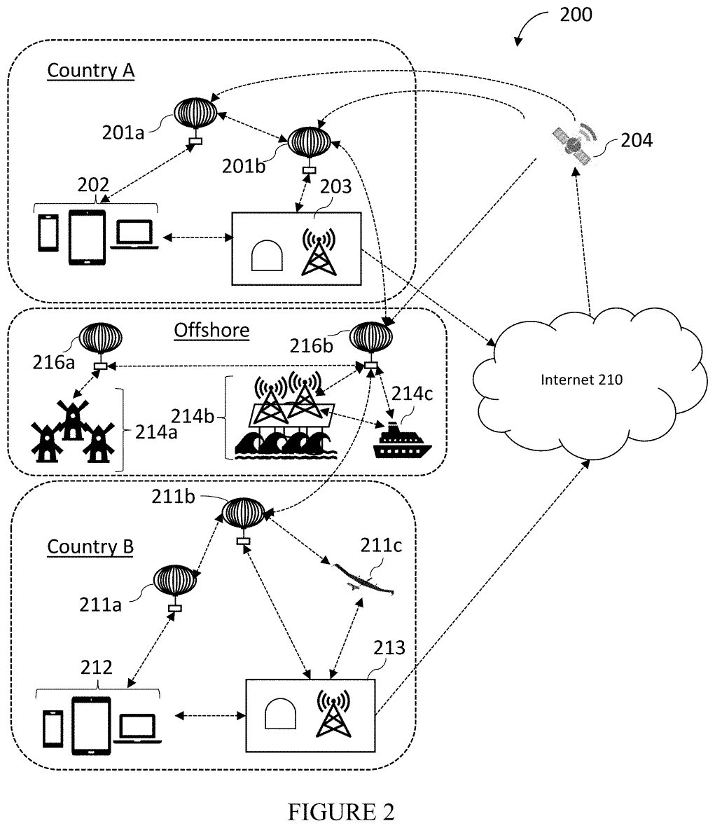

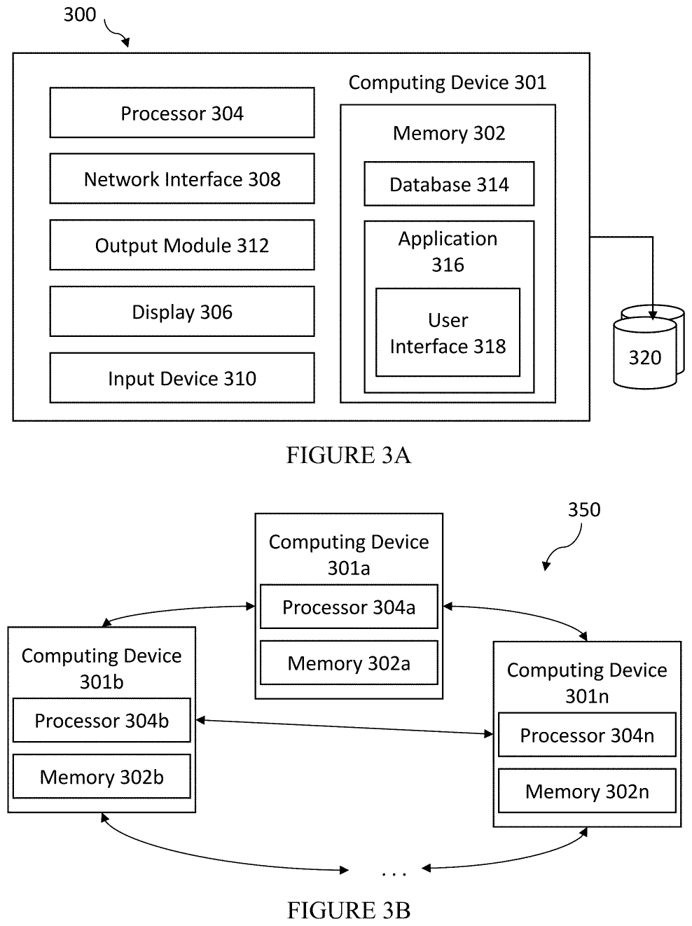

Ground station 114 may include one or more server computing devices 115a-n, which in turn may comprise one or more computing devices (e.g., computing device 301 in FIG. 3). In some examples, ground station 114 also may include one or more storage systems, either housed within server computing devices 115a-n, or separately (see, e.g., computing device 301 and repositories 320). Ground station 114 may be a datacenter servicing various nodes of one or more networks (e.g., aerial vehicle network 200 in FIG. 2).

FIG. 1B shows a diagram of system 150 for control of aerial vehicle 120b. All like-numbered elements in FIG. 1B are the same or similar to their corresponding elements in FIG. 1A, as described above (e.g., balloon 101a and balloon 101b may serve the same function, and may operate the same as, or similar to, each other). In some examples, balloon 101b may comprise an airship hull or dirigible balloon. In this embodiment, aerial vehicle 120b further includes, as part of payload 108b, propellers 107, which may be configured to actively propel aerial vehicle 120b in a desired direction, either with or against a wind force to speed up, slow down, or re-direct, aerial vehicle 120b. In this embodiment, balloon 101b also may be shaped differently from balloon 101a, to provide different aerodynamic properties. In some examples, balloon 101b may include one or more fins (not shown) coupled to one or more of a rear, upper, lower, or side, surface (i.e., relative to a direction in which balloon 101b is heading).

As shown in FIGS. 1A-1B, aerial vehicles 120a-b may be largely wind-influenced aerial vehicles, for example, balloons carrying a payload (with or without propulsion capabilities) as shown, or fixed wing high altitude drones (e.g., aerial vehicle 211c in FIG. 2) with gliding and/or full propulsion capabilities. However, those skilled in the art will recognize that the systems and methods disclosed herein may similarly apply and be usable by various other types of aerial vehicles.

FIG. 2 is a diagram of an exemplary aerial vehicle network, in accordance with one or more embodiments. Aerial vehicle network 200 may include aerial vehicles 201a-b, user devices 202, and ground infrastructure 203, in Country A. Aerial vehicle network 200 also may include aerial vehicles 211a-c, user devices 212, and ground infrastructure 213 in Country B. Aerial vehicle network 200 also may include offshore facilities 214a-c and aerial vehicles 216a-b servicing at least said offshore facilities 214a-c. Aerial network 200 may further include satellite 204 and Internet 210. Aerial vehicles 201a-b, 211a-c, and 216a-b may comprise balloon, other floating (i.e., lighter than air), propelled or partially propelled (i.e., propelled for a limited amount of time or under certain circumstances, and not propelled at other times or under other circumstances), fixed-wing, or other types of high altitude aerial vehicles, as described herein. For example, aerial vehicles 201a-b, 211a-c, and 216a-b may be the same or similar to aerial vehicles 120a-b described above. User devices 202 and 212 may include a cellular phone, tablet computer, smart phone, desktop computer, laptop computer, and/or any other computing device known to those skilled in the art. Ground infrastructure 203 and 213 may include always-on or fixed location computing device (i.e., capable of receiving fixed broadband transmissions), ground terminal (e.g., ground station 114), tower (e.g., a cellular tower), and/or any other fixed or portable ground infrastructure for receiving and transmitting various modes of connectivity described herein known to those skilled in the art. User devices 202 and 212, ground infrastructure 203 and 213, and offshore facilities 214a-c, may be capable of receiving and transmitting signals to and from aerial vehicles 201a-b, 211a-c, and 216a-b, and in some cases, to and from each other. Offshore facilities 214a-c may include industrial facilities (e.g., wind farms, oil rigs and wells), commercial transport (e.g., container ships, other cargo ships, tankers, other merchant ships, ferries, cruise ships, other passenger ships), and other offshore applications.

Aerial vehicle network 200 may support ground-to-vehicle communication and connectivity, as shown between ground infrastructure 203 and aerial vehicle 201b, as well as aerial vehicles 211b-c and ground infrastructure 213. In these examples, aerial vehicles 201b and 211b-c each may exchange data with either or both a ground station (e.g., ground station 114), a tower, or other ground structures configured to connect with a grid, Internet, broadband, and the like. Aerial vehicle network 200 also may support vehicle-to-vehicle (e.g., between aerial vehicles 201a and 201b, between aerial vehicles 211a-c, between aerial vehicles 216a-b, between aerial vehicles 201b and 216b, between aerial vehicles 211b and 216b), satellite-to-vehicle (e.g., between satellite 204 and aerial vehicles 201a-b, between satellite 204 and aerial vehicle 216b), vehicle-to-user device (e.g., between aerial vehicle 201a and user devices 202, between aerial vehicle 211a and user devices 212), and vehicle-to-offshore facility (e.g., between one or both of aerial vehicles 216a-b and one or more of offshore facilities 214a-c) communication and connectivity. In some examples, ground stations within ground infrastructures 203 and 213 may provide core network functions, such as connecting to the Internet and core cellular data network (e.g., connecting to LTE EPC or other communications platforms, and a software defined network system) and performing mission control functions. In some examples, the ground-to-vehicle, vehicle-to-vehicle, and satellite-to-vehicle communication and connectivity enables distribution of connectivity with minimal ground infrastructure. For example, aerial vehicles 201a-b, 211a-c, and 216a-b may serve as base stations (e.g., LTE eNodeB base stations), capable of both connecting to the core network (e.g., Internet and core cellular data network), as well as delivering connectivity to each other, to user devices 202 and 212, and to offshore facilities 214a-c. As such, aerial vehicles 201a-b and 211a-c represent a distribution layer of aerial vehicle network 200. User devices 202 and 212 each may access cellular data and Internet connections directly from aerial vehicles 201a-b and 211a-c.

FIG. 3A is a simplified block diagram of an exemplary computing system forming part of the systems of FIGS. 1A-2, in accordance with one or more embodiments. In one embodiment, computing system 300 may include computing device 301 and storage system 320. Storage system 320 may comprise a plurality of repositories and/or other forms of data storage, and it also may be in communication with computing device 301. In another embodiment, storage system 320, which may comprise a plurality of repositories, may be housed in one or more of computing device 301 (not shown). In some examples, storage system 320 may store state data, commands (e.g., flight, navigation, communications, mission, fallback), and other various types of information as described herein. This information may be retrieved or otherwise accessed by one or more computing devices, such as computing device 301 and server computing devices 115a-n in FIGS. 1A-1B, in order to perform some or all of the features described herein. Storage system 320 may comprise any type of computer storage, such as a hard-drive, memory card, ROM, RAM, DVD, CD-ROM, write-capable, and read-only memories. In addition, storage system 320 may include a distributed storage system where data is stored on a plurality of different storage devices, which may be physically located at the same or different geographic locations (e.g., in a distributed computing system such as system 350 in FIG. 3B). Storage system 320 may be networked to computing device 301 directly using wired connections and/or wireless connections. Such network may include various configurations and protocols, including short range communication protocols such as Bluetooth™, Bluetooth™ LE, the Internet, World Wide Web, intranets, virtual private networks, wide area networks, local networks, private networks using communication protocols proprietary to one or more companies, Ethernet, WiFi and HTTP, and various combinations of the foregoing. Such communication may be facilitated by any device capable of transmitting data to and from other computing devices, such as modems and wireless interfaces.

Computing device 301 also may include a memory 302. Memory 302 may comprise a storage system configured to store a database 314 and an application 316. Application 316 may include instructions which, when executed by a processor 304, cause computing device 301 to perform various steps and/or functions, as described herein. Application 316 further includes instructions for generating a user interface 318 (e.g., graphical user interface (GUI)). Database 314 may store various algorithms and/or data, including neural networks (e.g., encoding flight policies, as described herein) and data regarding wind patterns, weather forecasts, past and present locations of aerial vehicles (e.g., aerial vehicles 120a-b, 201a-b, 211a-c), sensor data, map information, air traffic information, among other types of data. Memory 302 may include any non-transitory computer-readable storage medium for storing data and/or software that is executable by processor 304, and/or any other medium which may be used to store information that may be accessed by processor 304 to control the operation of computing device 301.

Computing device 301 may further include a display 306, a network interface 308, an input device 310, and/or an output module 312. Display 306 may be any display device by means of which computing device 301 may output and/or display data. Network interface 308 may be configured to connect to a network using any of the wired and wireless short range communication protocols described above, as well as a cellular data network, a satellite network, free space optical network and/or the Internet. Input device 310 may be a mouse, keyboard, touch screen, voice interface, and/or any or other hand-held controller or device or interface by means of which a user may interact with computing device 301. Output module 312 may be a bus, port, and/or other interface by means of which computing device 301 may connect to and/or output data to other devices and/or peripherals.

In some examples computing device 301 may be located remote from an aerial vehicle (e.g., aerial vehicles 120a-b, 201a-b, 211a-c) and may communicate with and/or control the operations of an aerial vehicle, or its control infrastructure as may be housed in avionics chassis 110a-b, via a network. In one embodiment, computing device 301 is a data center or other control facility (e.g., configured to run a distributed computing system as described herein), and may communicate with a controller and/or flight computer housed in avionics chassis 110a-b via a network. As described herein, system 300, and particularly computing device 301, may be used for planning a flight path or course for an aerial vehicle based on wind and weather forecasts to move said aerial vehicle along a desired heading or within a desired radius of a target location. Various configurations of system 300 are envisioned, and various steps and/or functions of the processes described below may be shared among the various devices of system 300, or may be assigned to specific devices.

FIG. 3B is a simplified block diagram of an exemplary distributed computing system that may be used to perform health and lifetime estimation methods, in accordance with one or more embodiments. System 350 may comprise two or more computing devices 301a-n. In some examples, each of 301a-n may comprise one or more of processors 304a-n, respectively, and one or more of memory 302a-n, respectively. Processors 304a-n may function similarly to processor 304 in FIG. 3, as described above. Memory 302a-n may function similarly to memory 302 in FIG. 3, as described above.

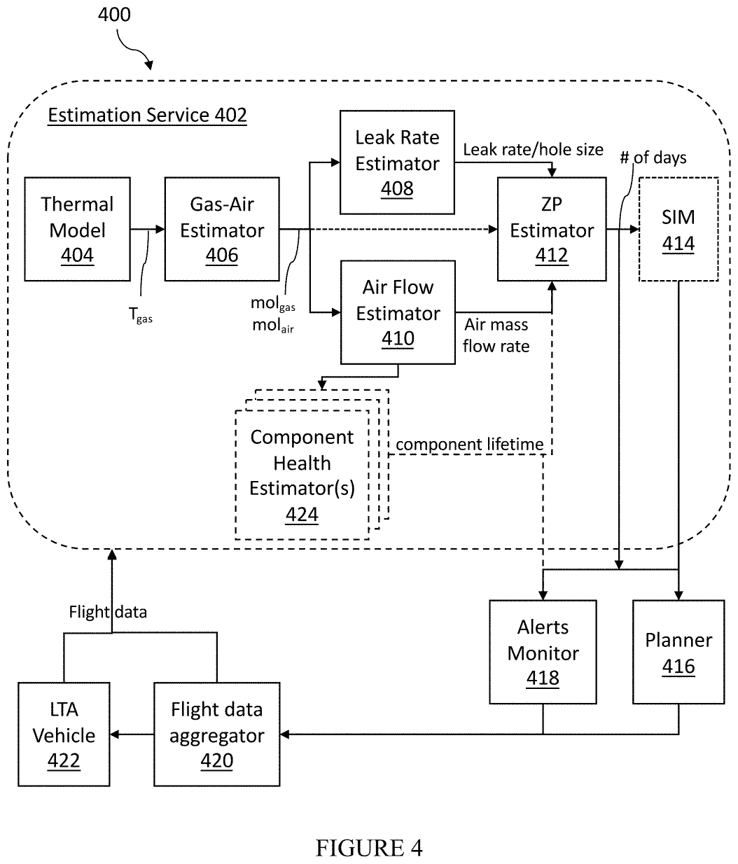

FIG. 4 is a simplified block diagram of an exemplary LTA vehicle health and estimation system, in accordance with one or more embodiments. System 400 includes estimation service 402, planner 416, alerts monitor 418, flight data aggregator 420 and LTA vehicle 422. Estimation service 402 may comprise thermal model 404, gas-air estimator 406, leak rate estimator 408, air flow estimator 410, and zero pressure estimator 412. In some examples, estimation service 402 also may include component health estimator(s) 424 configured to estimate a lifetime of an individual component (i.e., component lifetime). Component health estimator(s) 424 may include an ACS health estimator, a solar health estimator, a battery power health estimator, among other component health estimators. Each component health estimator 424 may be configured to determine a probability of failure for a component (e.g., an ACS, a solar power system, a battery system (e.g., one or more battery packs), and the like). In an example, component health estimator 424 may include an ACS health estimator configured to receive or obtain inputs of air mass flow rate (e.g., from air flow estimator 410), ACS cycles, valve and flow rate failure instances (e.g., frequency, nature of failure), and other ACS data, for example, as part of flight data from LTA vehicle 422 and flight data aggregator 420. The ACS health estimator may be configured to estimate an ACS lifetime (e.g., a length of time wherein the probability of an ACS failure reaches an ACS failure probability threshold) based on these inputs. In another example, component health estimator 424 may include a battery power health estimator configured to receive or obtain inputs of a number of day-night charging cycles, a battery age, a level of battery deterioration, and any single battery cell or battery pack component failure, for example, as part of flight data from LTA vehicle 422 and flight data aggregator 420. The battery power health estimator may be configured to estimate a battery system lifetime (e.g., a length of time wherein the probability of a battery system failure reaches a battery system failure probability threshold) based on these inputs. In some examples, any one or more of component health estimator(s) 424 may provide component health estimation data to zero pressure estimator 412 and alerts monitor 418, as shown. In other examples, one or more of component health estimator(s) 424 also may provide component health estimation data directly to simulator 414 and/or planner 416 (not shown).

In some examples, estimation service 402 also may include simulator 414 configured to perform a plurality of simulations to determine probabilities of a terminal event (e.g., bursting and zero pressure events, battery and ACS failure events) based on the remaining lifetime output and a flight plan or trajectory (e.g., Monte Carlo simulation, computing the probability of a termination event based on a vehicle's mission, which may be constrained by various mission-related factors, such as geography, flight plan, type of service, length of service). For example, simulator 414 may output lifetime probabilities for LTA vehicle 422 or another vehicle in the fleet, based on the most constraining component (i.e., component with the shortest estimated lifespan) or terminal event (i.e., terminal event most likely to occur earlier). In other examples, simulator 414 may be subsumed in zero pressure estimator 412. In still other examples, estimator service 402 may include other estimators, not shown, that may estimate other aspects of a vehicle's health, including without limitation, a wind and navigation estimator (e.g., wind gaussian process, weather model estimator), an ACS efficiency estimator, a power estimator, a system reboot estimator, a parachute success estimator, a physics filter, ballast estimator, solar estimator, among others. Estimators may be interdependent (e.g., forming a dependency tree and/or feedback loop), and while an exemplary flow is shown in FIG. 4, estimator outputs may flow in different ways than shown.

Estimation service 402 may be configured to receive flight data, for example, from one or both of LTA vehicle 422 (i.e., non-aggregated flight data) and flight data aggregator 420 (i.e., aggregated flight data). Estimation service 402 (e.g., by zero pressure estimator 412 and/or simulator 414) further may be configured to output an estimated lifespan or remaining lifetime for an LTA vehicle, as well as other information, including an amount of gas left in a vehicle, a failure rate of the ACS system as a function of cycles (e.g. how many days of use until the probability of ACS failure goes above a predetermined threshold), battery capacity deterioration rate (e.g., whether there is sufficient battery life and performance to complete the vehicle's mission or operate through a night or other period of time without solar energy production), a probability of envelope film failure (e.g. based on film-based properties such as elasticity, hoop stress, how much time spent above a given strain rate (e.g., solar flux and strain), UV degradation, thermal stress). In an example, the most limiting of such factors may determine a remaining lifetime of a vehicle (e.g., determine a time to take a vehicle out of service if any one probability (e.g., of bursting, of zero pressuring, of insufficient battery performance, of ACS failure, etc.) falls below a respective threshold probability (e.g., bursting probability threshold, zero pressure probability threshold, insufficient battery performance probability threshold, ACS failure threshold, etc.).

In some examples, a remaining lifetime output may comprise a value indicating a remaining lifetime (e.g., in number of days). Other remaining lifetime outputs may comprise a probabilistic output (e.g., resulting from simulations by simulator 414 and/or zero pressure estimator 412), including a probability of experiencing a terminal event (i.e., an event requiring landing the vehicle) or conversely a probability of not experiencing a terminal event (e.g., a forecast for each day or other time increment (e.g., hours, weeks, months, etc) to a given horizon), probabilities of a vehicle having a lifespan of a desired length (e.g., number of days, weeks), a highest lifespan length for which a probability meets or exceeds a threshold lifetime probability, or other probabilistic outputs. In still other examples, the remaining lifetime may be represented as a survival curve and intersecting a weather forecast (or odds of being below a zero pressure temperature on the curve) for the vehicle's position at each time on a given horizon with the survival curve to determine odds or estimate of the vehicle's longevity. In some examples, the remaining lifetime output may indicate a life expectancy of the vehicle before a burst or zero pressure event is expected to occur.

Outputs from estimation service 402 may be provided to alerts monitor 418, which may be configured to send automated alerts to a vehicle (e.g., LTA vehicle 422), for example, to turn a component on or off, to switch modes (e.g., a fallback mode, a landing mode, an evaluation or test mode, re-initiate an operational mode), to ascend or descend, to take an emergency measure, or relay other automated alerts. Outputs from estimation service 402 also may be provided to planner 416, which may be configured to generate and modify flight plans (e.g., flight commands and instructions, dynamic maps indicating probabilistic flight trajectories, or other formats). In some examples, planner 416 may implement cost functions that rely on lifetime estimation outputs from estimation service 402. Outputs from estimation service 402 also may be provided to various other flight and fleet management systems, including risk management systems, vehicle allocation and dispatcher systems. For example, a remaining lifetime estimate may be merged or aggregated (e.g., by flight data aggregator 420 with other health estimates or lifetime estimates for other vehicles in a fleet) to generate a risk profile or longevity estimate for the flight system or fleet as a whole.

Flight data inputs from LTA vehicle 422 and flight data aggregator 420 may include current flight data (e.g., ambient temperature, upwelling infrared radiation (IR) and other IR, solar radiation, pressure, location, weather, battery charge, solar power generation, component states (e.g., on, off, unresolved bugs)), vehicle flight historical data (e.g., days in flight, conditions flown (e.g., temperatures, altitudes, distance, geographical regions experienced so far in the flight), ACS activity, reported and/or resolved bugs and failures, number of reboots), characteristics of the vehicle (e.g., system mass, ballonet and other materials characteristics, volume, hardware and software versions and/or capabilities, battery or other power capacity), as well as modeled input parameters (e.g., convection, vehicle energy emissions (e.g., black body radiation, radiant heat, and other radiant energy)).

Thermal model 404 may be configured to determine a gas temperature based on one, or a combination, of sensor data from local sensors (e.g., local to a hull or balloon envelope for LTA vehicle 422), simulations, a gas temperature range based on an expected flight path (e.g., based on weather forecasts and/or historical data), calculations based on ambient temperature, ambient pressure and local heat fluxes. In some examples, there may be sufficient confidence level in the sensor data to rely solely or heavily on the sensor data to determine a gas temperature (e.g., lift gas temperature sensors may have an optimal temperature range in which they operate optimally, providing more accurate and reliable temperature readings, outside of which said sensor measurements may be unreliable).

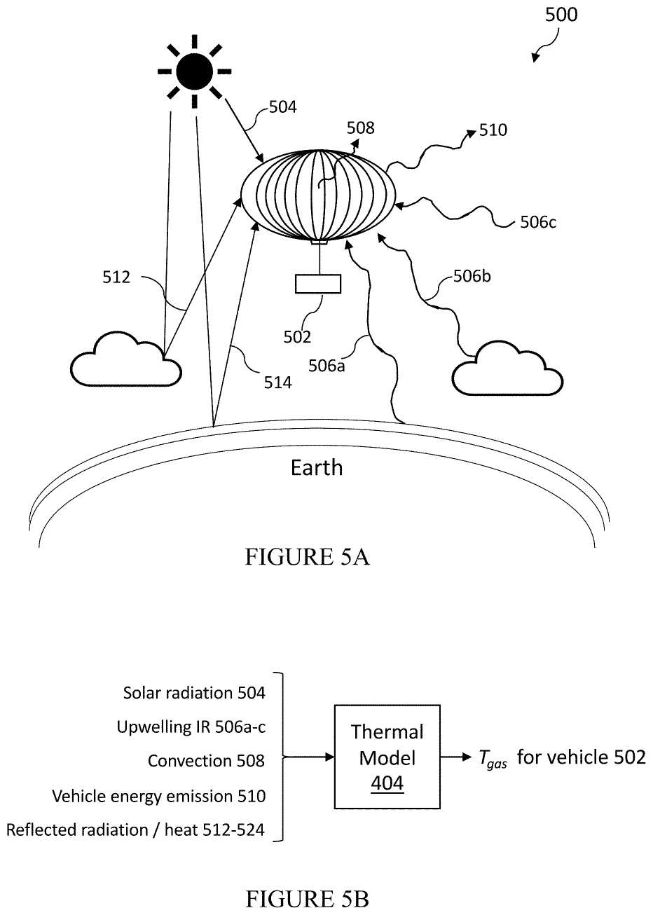

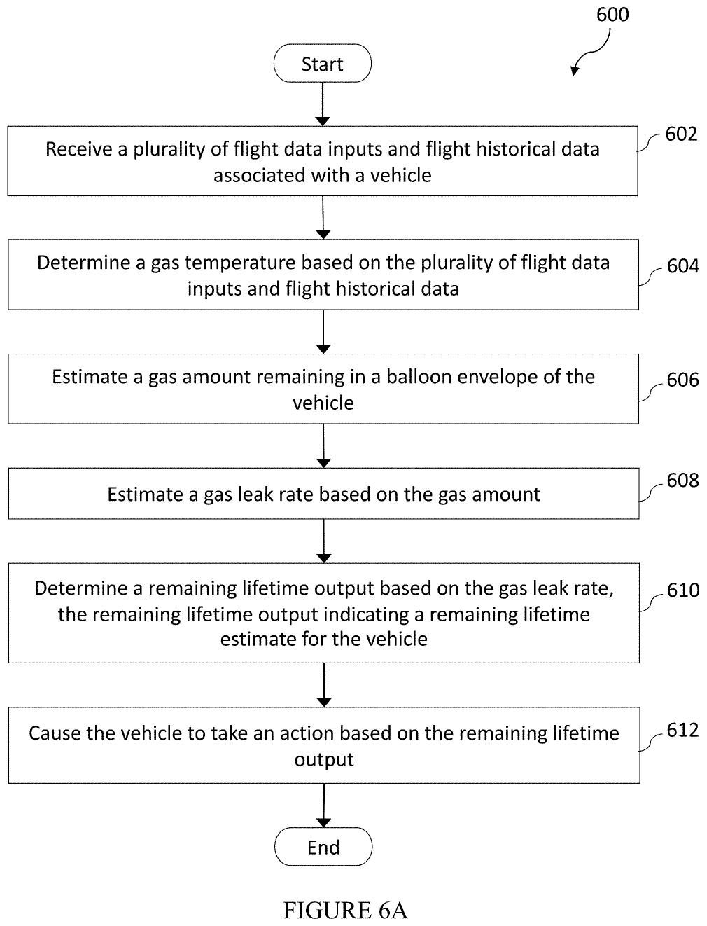

In other examples, thermal model 404 may infer or derive a gas temperature based on various inputs, as shown in FIGS. 5A-5B. FIG. 5A is a simplified diagram of exemplary sources of thermal radiation that may be considered in, and FIG. 5B is a simplified block diagram of exemplary inputs and outputs of a thermal model in the LTA vehicle health and estimation system of FIG. 4. Such inputs to thermal model 404 may include, without limitation, solar radiation 504 (qₛᵤₙ), upwelling infrared radiation (IR) 506a-c (e.g., from Earth (q_{earthIR}), surrounding clouds (q_{cloudIR}), atmosphere or sky (q_{skyIR}), and other sources of infrared radiation, as measured directly by sensors (i.e., during times when sensor measurement confidence levels are higher) or derived from historical data or weather models (i.e., during times when sensor measurement confidence levels are lower)), convection 508 (e.g., internal (film and gas) and external (film and air)), vehicle energy emissions 510 (e.g., black body radiation by a balloon envelope or aerostat hull), and reflected heat 512-514. In some examples, thermal model 404 also may be configured to derive and/or model convection 508 and vehicle energy emissions 510 (e.g., black body radiation, radiant heat, and other radiant energy). Thermal model 404 may use any one or combination of these inputs to compute a gas temperature T_{gas} (e.g., for vehicle 502).

In an example, thermal model 404 may rely more heavily on lift gas temperature sensor measurements of lift gas temperature during an ascent or at night, when temperatures do not exceed a temperature threshold beyond which a lift gas temperature sensor may be reliable. Thermal model 404 may be configured to fuse lift gas temperature sensor data with a modeled gas temperature estimate derived using IR sensor data and a thermal model, as described in FIGS. 5A-5B, to achieve a more accurate gas temperature estimate. However, thermal model 404 may rely less on, or prune from inputs, IR sensor data based thermal inputs during sunrise, sunset, or given maneuvers where historical IR data shows IR sensor measurements to be unreliable (i.e., less accurate, lower confidence levels). During these times, IR inputs may be based on modeling of historical IR data or forecasted IR data from a weather model such as ECMWF HRES instead and/or lift gas temperature sensor measurements. Such fused IR and lift gas temperature estimates, and otherwise weighting of different thermal radiation inputs as described above, result in improved performance of thermal model 404.

Gas-air estimator 406 may be configured to determine an amount of gas (mol_{gas}) and air (molₐᵢᵣ) remaining in a vehicle (e.g., LTA vehicle 422) based on a gas temperature T_{gas} determined by the thermal model 404, as well as inputs (e.g., flight data inputs) relating to system mass, a balloon volume model, envelope and ballonet material (i.e., film) characteristics, ambient temperature, and internal and external pressure measurements (e.g., ambient pressure and internal gas pressure). Air flow rate estimator 410 may be configured to determine a rate of flow of air mass (i.e., air mass flow rate) in or out of the ballonet based on the air mass estimates output by the gas and air estimator, as well as ACS activity (e.g., ascents/descents, power settings during maneuvers). Leak rate estimator 408 may be configured to determine one or both of a gas leak rate and a hole size based on the volume of gas and air output by the gas and air estimator (i.e., gas and air volume output). Leak rate estimator 408 may be configured to determine one or both of a gas leak rate and a hole size based on the gas mass estimates output by the gas and air estimator. Leak rate estimator 408 may use a filter (e.g., Kalman filter, extended Kalman filter) to determine a gas leak rate and a hole size even given relatively noisy gas and air mass estimates as inputs. In an example, leak rate estimator 408 may implement a physics filter using an extended Kalman filter, assuming a single hole in a vehicle envelope, and taking into account an ACS state (e.g., open valves, leaking valves, descent mass flow rates). The physics filter may be configured to estimate biases in volume or mass vehicle flight data, thereby improving gas and air mass estimates and leading to more accurate leak rate and hole size estimation.

Zero pressure estimator 412 may be configured to determine a remaining lifetime output (e.g., value, probability, survival curve indicating zero pressure predictions by temperature and time, other projection of failure probabilities or longevity estimations by intersecting vehicle position and weather forecast at a given time) based on an air mass flow rate, a gas leak rate, and a hole size, as output by air flow rate estimator 410 and leak rate estimator 408. In some examples, zero pressure estimator 412 also may be configured to base or modify the remaining lifetime output based on component lifetime information from component health estimator(s) 424, the remaining lifetime output representing a most constraining factor—a zero pressure or other terminal event likelihood if component lifetimes are greater (i.e., longer), or vice versa if there is a component lifetime that is more constraining than the likelihood of a zero pressure or other terminal event.

Simulator 414 may perform a plurality of simulations to determine probabilities of a terminal event (e.g., bursting and zero pressure events, battery and ACS system failure events) based on the remaining lifetime output of zero pressure estimator 412 and a flight plan or trajectory (e.g., Monte Carlo simulation, computing the probability of a termination event based on a vehicle's mission, which may be constrained by various mission-related factors, such as geography, flight plan, type of service, length of service). In some examples, the results of the simulations (e.g., probability of a vehicle having a lifespan of a desired length (e.g., number of days, weeks), the highest lifespan length for which the probability meets or exceeds a threshold lifetime probability) may be provided to an alerts monitor configured to send alerts to the vehicle and a planner configured to generate and modify flight plans. The output lifetime estimate also may be provided to various other flight and fleet management systems, including risk management systems, vehicle allocation and dispatcher systems. For example, the remaining lifetime estimate also may be merged (e.g., with other health estimates or lifetime estimates for other vehicles in a fleet) to generate a risk profile or longevity estimate for the flight system as a whole, or used to determine when to take individual flight vehicles out of service.

In other examples, an output from one or a combination of two or more of a gas-air estimator, leak rate estimator, air flow estimator, power system health estimator, and ACS health estimator (e.g., leak rate, hole size, air mass flow rate, ACS cycles, power and solar charging cycles) may be provided as input to a lifetime estimation module (not shown) comprising a zero pressure estimator and simulator. Zero pressure estimator 412, or a lifetime estimation module comprising zero pressure estimator 412 and simulator 414, may be configured to calculate an estimated lifespan as well as other information, including an amount of gas left in a vehicle, a failure rate of the ACS system as a function of cycles (e.g. how many days of use until the probability of ACS failure goes above a predetermined threshold), battery capacity deterioration rate (e.g., whether there is sufficient battery life and performance to complete the vehicle's mission or operate through a night or other period of time without solar energy production), a probability of envelope film failure (e.g. based on film-based properties such as elasticity, hoop stress, how much time spent above a given strain rate (e.g., solar flux and strain), UV degradation, thermal stress). In an example, the most limiting (i.e., constraining) of such factors may determine a remaining lifetime of a vehicle (e.g., determine a time to take a vehicle out of service if any one probability (e.g., of bursting, of zero pressuring, of insufficient battery performance, of ACS failure, etc.) falls below a respective threshold probability (e.g., bursting probability threshold, zero pressure probability threshold, insufficient battery performance probability threshold, ACS failure threshold, etc.).

Example Methods

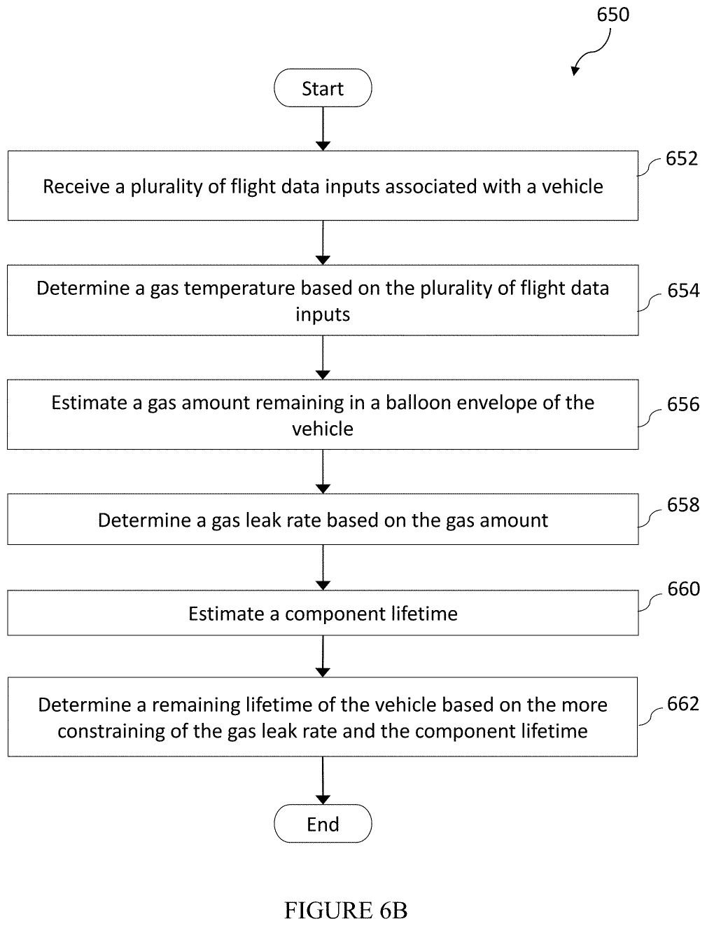

FIGS. 6A-6B are flow diagrams illustrating methods for LTA vehicle health and lifetime estimation, in accordance with one or more embodiments. Method 600 begins with receiving a plurality of flight data inputs and flight historical data associated with a vehicle at step 602. A gas temperature may be determined based on the plurality of flight data inputs and flight historical data at step 604. As described herein, gas temperature may be determined by a thermal model (e.g., thermal model 404 in FIG. 4). In some examples, determining the gas temperature includes modeling thermal properties of the vehicle based on one or more thermal radiation inputs. Such inputs may include solar radiation inputs (e.g., direct solar radiation), upwelling infrared radiation inputs (e.g., from the Earth, clouds, sky), convection inputs (e.g., due to balloon envelope film properties), vehicle energy emission inputs (e.g., black body radiation), and reflected heat inputs (e.g., solar radiation reflected off of clouds or the Earth). In other examples, determining the gas temperature comprises fusing an infrared radiation estimate and a lift gas temperature estimate, the infrared radiation estimate being based at least in part on an infrared radiation sensor measurement and the lift gas temperature estimate being based at least in part on a lift gas temperature sensor measurement. The infrared radiation sensor measurement and the lift gas temperature sensor measurement being weighted based on historical performance.

A gas amount remaining in the balloon envelope of the vehicle may be estimated at step 606, for example, by a gas-air estimator (e.g., gas-air estimator 406 in FIG. 4). In some examples, the gas amount is housed in a ballonet within the balloon envelope (e.g., in a reverse ballonet balloon design). A gas leak rate is estimated based on the gas amount at step 608, for example, by a leak rate estimator (e.g., leak rate estimator 408). A remaining lifetime output is determined based on the gas leak rate at step 610, the remaining lifetime output indicating a remaining lifetime estimate for the vehicle. In some examples, the remaining lifetime output also may be based on one or both of a hole size and air mass flow rate, which may be determined by a leak rate estimator and air flow estimator, respectively. In some examples, determining the remaining lifetime output may include simulating a terminal event (e.g., a burst event, a zero pressure event, or other event for which a landing is desirable). In some examples, an air amount remaining in the balloon envelope may also be estimated, the air amount comprising an amount of air pumped into and let out of the balloon envelope. An air mass flow rate may be determined based on the air amount, and may be considered in determining the remaining lifetime output.

In some examples, the remaining lifetime output may comprise a value indicating the remaining lifetime estimate. In other examples, the remaining lifetime output comprises a probability that the vehicle will experience a terminal event within the remaining lifetime estimate, or other probability relating to the vehicle lifetime, as described herein. In still other examples, the remaining lifetime output comprises a survival curve predicting a likelihood of a terminal event over temperature (i.e., a temperature axis representing temperature data from forecasts or nowcasts as described herein) and time (i.e., a time axis). The time axis may represent an expected time for a mission, a maximum lifetime for the fleet or a vehicle type, or longer.

In some examples, the method further includes an optional step of causing the vehicle to take an action based on the remaining lifetime output at step 612. In some examples, step 612 may involve providing the remaining lifetime output to an alerts monitor configured to send an alert to the vehicle. As described herein, the alerts system may send automated alerts, and the alerts may include commands configured to cause the vehicle to turn a component on or off, to switch modes, to ascend or descend, to take an emergency measure, or perform other functions. In other examples, step 612 may involve providing the remaining lifetime output to a planner configured to generate or modify a flight plan for the vehicle. For example, causing the vehicle to take an action may include providing the remaining lifetime output to a planner, which may modify a flight plan for the vehicle and send a command to the vehicle based on the flight plan (e.g., to take the vehicle out of service or send it to land in or near a recovery area).

In FIG. 6B, method 650 may begin with receiving a plurality of flight data inputs associated with a vehicle at step 652. A gas temperature may be determined based on the plurality of flight data inputs at step 654. A gas amount remaining in a balloon envelope of the vehicle may be estimated at step 656. A gas leak rate may be determined based on the gas amount at step 658. A component lifetime may be estimated at step 660. As described herein, the component lifetime may comprise an estimated lifetime for one or more components of the vehicle, such as an ACS, a solar power system (i.e., a plurality of solar panels), a battery power system, envelope film, among other components for which a failure or performance below a component performance threshold would favor a termination (i.e., landing or cutdown) of the vehicle. This step 660 may include estimating a number of days until a likelihood of the component performing below a component performance threshold. A remaining lifetime of the vehicle may be determined (e.g., by a zero pressure estimator and/or a simulator) based on the more constraining of the gas leak rate and the component lifetime at step 662, for example, by a zero pressure estimator and/or simulator, as described herein. This step 662 may include estimating a number of days until a likelihood of the vehicle experiencing a zero pressure event exceeds a zero pressure probability threshold. For example, if the gas leak rate indicated a small probability (i.e., far below a zero pressure probability threshold) that the vehicle would zero-pressure in N number of days, and an ACS health estimator indicated a higher probability (i.e., at or exceeding an ACS failure probability threshold) that the ACS would fail in the same N number of days, then the remaining lifetime may be determined to be N number of days based on the more constraining component lifetime of the ACS. In another example, an ACS health estimator may indicate a low probability of ACS failure in Y number of days and a battery power health estimator may indicate a low probability of a battery power system performing below a battery charge threshold (i.e., a maximum amount or percentage of capacity that the battery power system is able to charge during a day (e.g., a sunrise to a sunset)) in that same Y number of days, but the gas leak rate may indicate a probability of zero pressure conditions that meets or exceeds a zero pressure probability threshold in that same Y number of days, the remaining lifetime of the vehicle may be determined to be Y number of days. In other words, the remaining lifetime may represent the lesser of a likelihood of a vehicle experiencing a zero pressure or other terminal event and a component lifetime.

The component lifetime determined at step 660 and/or remaining lifetime determined at step 662 may be provided one or more of a zero pressure estimator, a simulator, an alerts monitor, and a planner, for example, to alert the vehicle in flight of an action to take, plan an alternate trajectory or heading for the vehicle, cause the vehicle to power a component on or off, or otherwise provide a command to the vehicle. In some examples, the remaining lifetime also may be provided to various other flight and fleet management systems, including risk management systems, vehicle allocation and dispatcher systems. In some examples, the remaining lifetime or one or more component lifetimes may be merged (e.g., with other health estimates or lifetime estimates for other vehicles in a fleet) to generate a risk profile or longevity estimate for the flight system as a whole, and to determine when to take a vehicle out of service. In still other examples, additional steps described above as part of method 600 in FIG. 6A also may be performed as part of method 650 in FIG. 6B.

While specific examples have been provided above, it is understood that the present invention can be applied with a wide variety of inputs, thresholds, ranges, and other factors, depending on the application. For example, the time frames and ranges provided above are illustrative, but one of ordinary skill in the art would understand that these time frames and ranges may be varied or even be dynamic and variable, depending on the implementation.

As those skilled in the art will understand, a number of variations may be made in the disclosed embodiments, all without departing from the scope of the invention, which is defined solely by the appended claims. It should be noted that although the features and elements are described in particular combinations, each feature or element can be used alone without other features and elements or in various combinations with or without other features and elements. The methods or flow charts provided may be implemented in a computer program, software, or firmware tangibly embodied in a computer-readable storage medium for execution by a general-purpose computer or processor.

Examples of computer-readable storage mediums include a read only memory (ROM), random-access memory (RAM), a register, cache memory, semiconductor memory devices, magnetic media such as internal hard disks and removable disks, magneto-optical media, and optical media such as CD-ROM disks.

Suitable processors include, by way of example, a general-purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, or any combination of thereof.

What is claimed is:

1. A lighter-than-air (LTA) vehicle health and lifetime estimation system comprising:
a processor; and
a memory comprising program instructions executable by the processor to cause the processor to implement:
an estimation service configured to determine a remaining lifetime output, the estimation service comprising:
a thermal model configured to determine a gas temperature,
a gas and air estimator configured to estimate a gas amount and an air amount remaining in a balloon of the LTA vehicle,
a leak rate estimator configured to estimate a leak rate based on the gas amount, and
a zero pressure estimator configured to determine the remaining lifetime output based on the leak rate; and
a simulator configured to simulate a terminal event based on the remaining lifetime output.

2. The system of claim 1, further comprising an air flow estimator configured to determine an air mass flow rate based on the air amount, wherein the zero pressure estimator is further configured to consider the air mass flow rate in determining the remaining lifetime output.

3. The system of claim 1, wherein the estimation service is configured to receive flight data.

4. The system of claim 3, wherein the flight data comprises current flight data from a vehicle.

5. The system of claim 3, wherein the flight data comprises historical flight data from a vehicle.

6. The system of claim 3, wherein the flight data comprises a characteristic of a vehicle.

7. The system of claim 3, wherein the flight data comprises a modeled input parameter.

8. The system of claim 3, wherein the flight data comprises aggregated flight data from a flight data aggregator.

9. The system of claim 1, wherein the remaining lifetime output comprises a value.

10. The system of claim 1, wherein the remaining lifetime output comprises a probabilistic output.

11. The system of claim 1, wherein the remaining lifetime output comprises a survival curve.

12. The system of claim 1, wherein the thermal model determines the gas temperature based on one or more of sensor data, a plurality of simulations, an expected flight path, an ambient temperature, an ambient pressure, and local heat flux.

13. The system of claim 1, wherein the thermal model derives the gas temperature from one or more forms of radiation (q).

14. The system of claim 1, wherein the thermal model is configured to model one or both of convection and vehicle energy emissions for a vehicle.

15. The system of claim 1, wherein the thermal model is configured to rely more heavily on a lift gas temperature sensor measurement when the gas temperature is below a temperature threshold.

16. The system of claim 1, wherein the thermal model is configured to fuse a lift gas temperature sensor measurement with a modeled gas temperature estimate.

17. The system of claim 1, wherein the leak rate estimator is further configured to determine a hole size.

18. The system of claim 1, wherein the leak rate estimator estimates the leak rate using an extended Kalman filter.

19. The system of claim 1, wherein the simulator is configured to run a plurality of Monte Carlo simulations.

20. The system of claim 1, further comprising one or more component health estimators configured to determine a probability of failure for a component.

21. The system of claim 20, wherein the remaining lifetime output is further based on a component lifetime.

22. The system of claim 20, wherein the one or more component health estimators comprises an altitude control system (ACS) health estimator.

23. The system of claim 20, wherein the one or more component health estimators comprises a power system health estimator.
